(19) United States
(12) Patent Application Publication
(10) Pub. No.: US 2010/0250360 A1
(43) Pub. Date: Sep. 30, 2010

(54) Trading Platform for the Redemption of Promotional Currency from Multiple Loyalty Programs

(75) Inventors: Michael Edward Ball, Ottawa (CA); Bradley John Ball, Kitchener (CA)

Correspondence Address: PERLEY-ROBERTSON, HILL & MCDOUGALL LLP, 1400-340 Albert Street, OTTAWA, ON, K1R 0A5, CA

(73) Assignee: LOYALTYMATCH INC., Waterloo, ON (CA)

(21) Appl. No.: 12/742,105

(22) PCT Filed: Nov. 20, 2008
(86) PCT No.: PCT/CA08/02045

§ 371 Date: May 10, 2010

(30) Foreign Application Priority Data
Nov. 20, 2008 (CA) PCT/CA2008/002045

(51) Int. Cl. G06Q 30/00

(52) U.S. Cl. 705/14.29

(57) ABSTRACT

A trading platform to allow holders of points or miles in loyalty programs to monetize their holdings, or to barter rewards, and connects parties interested in buying reward items or services with pointsholders capable of redeeming points to obtain the desired rewards. The trading platform creates matches between parties and can obtain a matchmaking or brokerage fee in the process without having to interact with the loyalty program itself.

### CROSS REFERENCE TO RELATED APPLICATIONS

This application is a national phase entry of WO/2008/CA00020245 entitled “Trading Platform for Rewards Earned from Multiple Loyalty Programs” filed Nov. 20, 2008 which itself claims the benefit of priority to U.S. Provisional Patent Application No. 60/996,508 filed Nov. 20, 2007 entitled “Trading Platform for the Redemption of Promotional Currency from Multiple Loyalty Programs”, the contents of each are expressly incorporated herein by reference in their entirety.

### FIELD OF THE INVENTION

This invention relates generally to a trading platform that allows holders of points in loyalty programs to either barter rewards with holders of points in the same or other programs or monetize the points through selling reward items to others.

### BACKGROUND OF THE INVENTION

Loyalty programs are offered by a number of different organizations to solidify customer loyalty through offering rewards based on the accumulation of points.

By offering customers better rewards for higher point accumulation, point plans have encouraged consumers to hoard points. However, consumers have begun to realize that their rate of point accretion does not keep up with inflationary pressures in the point-based economy. This has resulted in an ever-increasing point backlog. As the points cannot typically be redeemed for cash, pointsholders often feel that their holding have little to no value.

Consumers have a somewhat hidden asset in loyalty program points, but often lack the ability to unlock the value of the asset. It is often not in the best interests of the administration of these programs to allow pointsholders to transfer points to each other, as the points could be aggregated by an individual to maximize value.

Often consumers have memberships in a number of different loyalty programs, but lack sufficient points in any of them to obtain the desired reward. Services, such as those offered by Points.com allow a user to move points from one loyalty program to another with a reduction in value along the way. Although this allows consumers to consolidate their points with a single program, the spread on program-to-program exchange rates is large due to the transaction charges applied by the programs and by the profit taken by the service. The ability of a consumer to exchange points between programs is also restricted to the programs that the service has partnered with. If the consumer belongs to programs that either have not or will not partner with a points exchange service, no exchange can be done.

Some brokerage services offer to purchase points from consumers. These services then redeem the aggregated points to obtain tickets or reward items that are then resold. Loyalty programs that permit point transfers typically apply a penalty in the transfer, so that the number of points is substantially reduced. This transfer penalty, in conjunction with a small per-transferred-point-payout, provides most pointsholders with very little financial reward.

Thus consumers seeking to realize a benefit from one or more programs are often limited to selecting rewards from the reward catalogue associated with the loyalty programs. In the alternate, the held points are monetized at a vastly undervalued level.

Online marketplaces, such as E-Bay, Swapthing.com, Swaptree.com and peerflix.com, allow users to either sell or barter goods with one another. Numerous problems exist with these services, including the fact that they require vendors to list products without foreknowledge that the product has a market. Even if there is a market for the product, the vendor is not provided a mechanism to determine an appropriate price point in advance of an auction close. Furthermore, some items, such as airline tickets are not easily sellable because carriers do not typically permit re-sale of a ticket for a number of reasons.

In view of the ever-increasing backlog of accumulated loyalty program points, there is a need for a system and method to allow points holders to monetize their holdings.

### SUMMARY OF THE INVENTION

It is an object of the present invention to obviate or mitigate at least one disadvantage of the prior art.

In a first aspect of the present invention, there is provided a method of matching a buyer to one of a plurality of pointsholders, registered at a trading platform, associated with at least one loyalty program and having points with the at least one loyalty program and having an account with the trading platform stored in a database. The method comprises the steps of receiving, from the buyer through a network connection, an offer to purchase a selected reward associated with the at least one loyalty program; selecting, from the database, a pointsholder associated with the at least one loyalty program associated with the selected reward from the plurality of pointsholders; and connecting the selected pointsholder and buyer to permit the selected pointsholder to sell the reward to the buyer.

In an embodiment of the first aspect of the present invention, the selected reward requires a predetermined number of points in the at least one loyalty management program and the step of selecting a pointsholder includes selecting a pointsholder from the plurality of pointsholders having sufficient points with the at least one loyalty program to acquire the reward. In another embodiment, the step of selecting a pointsholder is done in accordance with pointsholder profiles at the trading platform and a catalogue associated with the at least one loyalty program and the offer received from the buyer includes conditions including a price. In a further embodiment, the step of selecting a pointsholder includes selecting a pointsholder willing to execute a transaction at a price-per-point ratio determined in accordance with the offered price and the catalogue associated with the at least one loyalty program. In another embodiment of the present invention, the step of selecting a pointsholder includes selecting a set of pointsholders in accordance with the points each of the selected set have with the at least one program, and selecting a pointsholder from the selected set. Optionally, the step of selecting a pointsholder from the selected set includes selecting a subset of the selected pointsholders in accordance with predefined price-per-point ratios associated with each of the pointsholders, and then selecting a pointsholder from the selected subset and selecting a pointsholder from the selected subset includes issuing an offer to pointsholders in the selected subset, receiving a positive response from at least one pointsholder, and selecting one pointsholder associated with a positive response. In a further embodiment, the step of selecting a pointsholder from the selected set includes selecting a subset of the selected pointsholders in accordance with conditions set forth in the received offer and predetermined preferences associated with of the pointsholders and then selecting a pointsholder from the selected subset. Optionally, the step of selecting a pointsholder from the selected subset includes issuing an offer to pointsholders in the selected subset, receiving a positive response from at least one pointsholder, and selecting one pointsholder associated with a positive response.

In a further embodiment of the first aspect of the present invention. the buyer is a pointsholder registered with the trading platform and the offer to purchase includes a barter value for the selected reward. In a further embodiment, the offer to purchase specifies a reward with a loyalty program different from the at least one loyalty program associated with the buyer, and includes a barter value associated with the at least one loyalty program associated with the buyer. In another embodiment, the step of selecting a pointsholder includes selecting a pointsholder associated with at least one loyalty program offering the selected reward.

In another embodiment of the first aspect of the present invention, the step of connecting the selected pointsholder and buyer includes allowing the buyer and selected pointsholder to complete the transaction outside of the trading platform. In a further embodiment, the step of connecting the selected pointsholder and buyer includes assessing a levy on at least one of the buyer and pointsholder. In yet another embodiment of the present invention, the method further includes the step of generating a catalogue of available rewards from which the buyer can select a reward, the catalogue generated in accordance with the available rewards from the at least one loyalty program and the point totals of each of the plurality of pointsholders. Optionally, the generated catalogue is a union of a plurality of microcatalogues, each of the plurality of microcatalogues associated with one of the plurality of pointsholders and reflecting the rewards that the associated pointsholder can obtain from the at least one loyalty program associated with the pointsholder.

In accordance with a second aspect of the present invention, there is provided a trading platform for matching buyers of loyalty program rewards to pointsholders associated with a loyalty program. The platform comprises a pointsholder interface, a catalogue engine, a bidder interface, and a matching engine. The pointsholder interface receives enrollment requests from pointsholders associated with at least one loyalty program. The catalogue engine generates a microcatalogue for each pointsholder from whom an enrollment request is received, the microcatalogue generated in accordance with the at least one loyalty program associated with the user, and a points level associated with the pointsholder at the at least one associated loyalty program, and generates a catalogue in accordance with any generated microcatalogues, and provides a list of rewards stored in the generated catalogue in response to a browse request. The bidder interface receives a request to browse the catalogue from a bidder, and transmits the list of rewards to the bidder in response to receipt of the list from the catalogue engine, and receives from the bidder an offer on a selected reward. The matching engine examines the offer received through the bidder interface, selects a pointsholder associated with a loyalty program determined in accordance with the selected reward, and connects the selected pointsholder and the bidder associated with the received offer to permit completion of the transaction outlined in the received offer.

In an embodiment of the second aspect of the present invention, the catalogue engine includes a database for storing the catalogue and microcatalogues. In another embodiment of the present invention, the matching engine includes means to select a pointsholder in accordance with conditions associated with the bid and preferences associated with the pointsholder. Optionally, the matching engine includes means to select a pointsholder in accordance with the ability of the pointsholder to obtain the reward from the at least one associated loyalty program and means to levy a fee on at least one of the bidder and the selected pointsholder upon connecting the two. In another embodiment, the bidder interface includes means to differentiate between a received offer to purchase and a received offer to barter. Optionally, the matching engine includes means to select a pointsholder in accordance with a pointsholder preference for bartering when the received offer is an offer to barter.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram illustrating an exemplary data flow between nodes during a purchase transaction;

FIG. 2 is a block diagram illustrating an exemplary data flow between nodes during a barter transaction;

FIG. 3 is a flowchart illustrating a method of registering a pointsholder as a user at the trading platform;

FIG. 4 is a flowchart illustrating a method of matching a buyer to a pointsholder;

FIG. 5 is a flowchart illustrating a method of selecting a pointsholder to execute a transaction;

FIG. 6 is a flowchart illustrating a method of selecting a pointsholder;

FIG. 7 is a flowchart illustrating a method of matching pointsholders for a barter transaction; and

FIG. 8 is a block diagram illustrating a logical implementation of a system of the present invention.

### DETAILED DESCRIPTION

The present invention is directed to a trading platform that allows holders of points in loyalty management programs to barter rewards with each other and to monetize the held points.

The preset invention can provide pointsholders with a trading platform that allows for the monetization of promotional currencies, such as loyalty programs points, from multiple loyalty programs. One skilled in the art will appreciate that loyalty program points can be viewed as a virtual currency that can be exchanged for a number of products or services, but cannot easily be converted to a real currency. Through use of a marketplace enabled by the present invention, the virtual currency can be traded, resulting in the monetization of the points (also referred to in some specific loyalty programs as miles, e.g. Air Miles®).

In an environment employing the present invention, a trading platform is provided to allow registered pointsholders to monetize their virtual currency. Pointsholders register with the trading platform and indicate the loyalty programs that they belong to. The pointsholder can either provide the trading platform with an indication of the current points level in each program, or an automated process can be used. Automated processes may require that the pointsholder provide the trading platform with login information to an electronic platform for each of the loyalty programs. The trading platform then builds a catalogue based on the rewards that each pointsholder can obtain through the redemption of points through each loyalty program. Logically, each pointsholder has a microcatalogue that is associated with his account containing the rewards that are available to the pointsholder in each of the at least one loyalty programs that the pointsholder is associated with. The overall catalogue of available rewards is created by aggregating the microcatalogues associated with each user of the system. When a buyer accesses the trading platform he can view the network wide catalogue of rewards to find an item of interest.

A buyer can be registered with the system, and allowed to browse the catalogue of available items and services. One skilled in the art will appreciate that users need not necessarily be registered to browse the catalogue, but it is presently preferred that they be registered to bid on items. Because the network wide catalogue is the aggregation of the microcatalogues, when the buyer selects an item and places a bid, the trading platform can easily select a subset of registered pointsholders from whom the reward can be obtained. The buyer can be presented with historical pricing information for the selected reward, and in some embodiments, the buyer can be provided a minimum price point for the item based on preferences set by the pointsholders from whom they can obtain the item. The buyer can then place a bid on the reward; the bid preferably details the price willing to be paid, and conditions that must be met such as the ability to ship the reward to a particular geographic region.

The trading platform can narrow the number of pointsholders eligible to participate in the transaction based on conditions included in the buyer's bid. Some conditions can be implicit, such as the ability to have a reward item shipped to the geographic location of a buyer, and explicit, such as the willingness of the pointsholder to pay for expedited shipping of the reward. Based on the subset of all pointsholders a decision is made to select one of the subset willing to complete the transaction. At this time, neither the pointsholder nor the buyer knows anything other than an item is available and a priced offer has been made. The trading platform can use any of a number of methods to select the pointsholder, including a random selection, a round robin weighting, and offering the transaction to a number of eligible pointsholders and selecting the first to accept the priced bid.

Upon selecting the pointsholder to execute the transaction, the platform connects the buyer and pointsholder so that the transaction can be completed. In connecting the buyer and pointsholder, an acceptance of the offer can be obtained that indicates that both the buyer and pointsholder are committed to executing the transaction. At this time, one (or both) of the parties can be charged a transaction fee by the platform. The fee can be a flat fee, or a fee based on the price of the transaction.

The buyer and pointsholder are then connected to each other. The buyer transfers the agreed upon settlement to the pointsholder, using any of a number of different payment systems, including such conventional methods as mailing a cheque or using an electronic transaction such as an email based banking transfer or a dedicated payment system such as PayPal™. The pointsholder then orders the reward from the loyalty program and either reships the reward to the buyer, or has the reward sent to the buyer directly.

Because the only interaction that the trading platform has with the Loyalty program is done to build a catalogue, no formal relationship is required. As a result, the Loyalty Program typically cannot impose a transaction fee, maximizing the per-point value. The only interaction with the Loyalty Program is performed by the pointsholder, who already has a relationship. Furthermore, because the trading platform does not require a formal relationship with a particular program, adding a new reward program is simplified, as no complex legal agreements need to be prepared.

Because the platform does not necessarily partake in the settlement process, two pointsholders can barter rewards with each other using the same platform. To the platform, the payment is considered to be another reward instead of a monetary value. This allows a pointsholder in one program to obtain rewards in another program without spending money. In one example of this being used, a pointsholder in a Canadian rewards program can barter with a pointsholder in a U.S. rewards program for entertainment tickets, such as tickets to plays, in cities that are not available in their respective programs (the Canadian pointsholder can barter tickets to a Canadian performance for tickets to a performance in the United States).

The invention will now be described with relation to various figures. Reference may be made to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

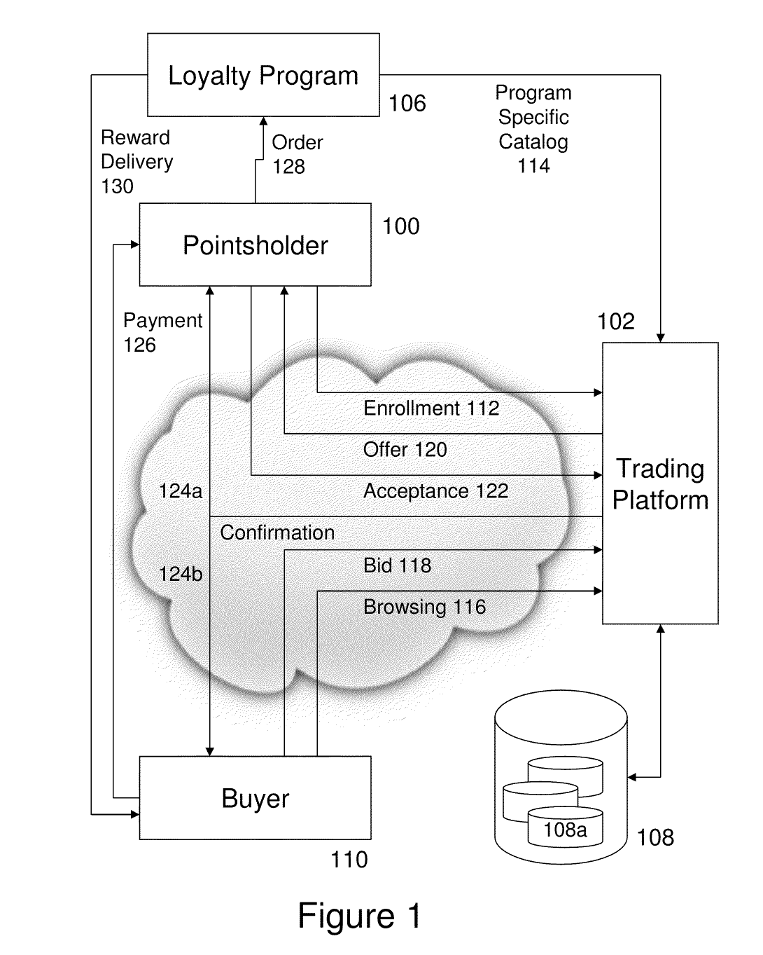

FIG. 1 illustrates a flow of information in a transaction where a buyer 110 purchases a reward. A pointsholder 100 connects to trading platform 102 through a data network such as the Internet 104, and holds points in Loyalty Program 106. A buyer 110 also connects to Trading Platform 104.

Pointsholder 100 connects to Trading Platform 102 through Internet 104 and enrolls over data connection 112. The enrollment process provides information about the pointsholder's membership with Loyalty Program 106, and preferably includes information regarding the number of points or miles held. This information can either be provided by the user in enrollment dataflow 112 or through a connection between Trading Platform 102 and Loyalty Program 106 (not illustrated). The pointsholder information used to create a profile allows the Trading Platform 102 to build a user specific microcatalogue 108a in conjunction with a program specific catalogue that is obtained from the loyalty program over catalogue data connection 114. The microcatalogue 108a is associated with the user profile. If the user subscribes to more than one loyalty reward program, the microcatalogue 108a includes the rewards available to the pointsholder through all of the programs the pointsholder is associated with. In the illustrated embodiment, only one Loyalty Program 106 is shown for the sake of clarity.

Buyer 110 conducts a shopping process over browsing dataflow 116. This process allows the buyer 110 to browse catalogue 108. The buyer 110 does not need to be aware of which rewards program offers which reward, or even aware of which pointsholder would be engaged to complete the transaction. During the shopping process, the buyer 110 can be provided information about any of the last selling price for a given item, a suggested selling price based on the average value associated with a point in a particular program, a suggested retail pricing, a comparison price obtained from online vendors and the number of points required to obtain the item. This information allows the buyer 110 to determine a bid price. The buyer 110 then issues a bid 118 for a selected item. Trading platform 102 receives the bid 118 and selects at least one pointsholder to execute the transaction. The mechanism for selecting a pointsholder to execute the transaction is described below. An offer 120 corresponding to bid 118 is generated by Trading Platform 102 and transmitted to Pointsholder 100, this offer may contain the same comparison pricing information provided to the buyer 110 during the browsing stage. The selected item will correspond to an item in the microcatalogue 108a of the points holder 100 to whom the offer 120 was transmitted. When the pointsholder 100 accepts the offer 120, an acceptance 122 is transmitted to the Trading Platform 102.

In a presently preferred embodiment, at least one of the buyer 110 and pointsholder 100 is obligated to pay a brokerage fee (sometimes referred to as a matchmaking fee) to the Trading Platform 102 upon the completion of the bid 118 and acceptance 122.

Upon receipt of acceptance 122, the Trading Platform 102 issues confirmation 124a to Pointsholder 100 and confirmation 124b to Buyer 110. These confirmation messages provide information to allow the Buyer 110 and the Pointsholder 100 to identify each other. This identification information is important for the next step in the process. The buyer 110 remits payment 126 to the pointsholder 100. Preferably, this payment is made in a manner that bypasses trading platform 102, and instead uses conventional transfer mechanisms such as a cheque, and electronic funds transfer, a wire transfer, use of PayPal™ or another payment system, or an email banking transfer. The pointsholder 100 then issues an order 128 for the purchased reward to Loyalty Program 106. This reward is then delivered through delivery dataflow 130 to Buyer 110. In the illustrated embodiment the reward is directly shipped to the Buyer 110, but in other embodiments, the reward may be shipped to the Pointsholder 100 and then forwarded to the Buyer 110.

Because the order 128 is placed by Pointsholder 100, no other node interacts directly with Loyalty Program 106, and thus no formal relationship between Trading Platform 102 and Loyalty Program 106 is required. Though the illustrated embodiment illustrates only one pointsholder 100, it is recognized that there will often be more than one pointsholder that can execute the transaction with Buyer 100. The Trading Platform 102 preferably selects a pointsholder based on a number of conditions. In cases where certain loyalty programs will not ship to the location of the buyer, the Trading Platform 102 can use that information as a criterion in the selection of the pointsholder. Similarly, if a pointsholder has indicated that they will not accept an offer that values a point under a threshold, and the bid does not provide sufficient valuation, the pointsholder will be removed from the pool of eligible pointsholders. After a set of pointsholders that can execute the transaction are selected any of a number of different selection methods can be used as will be discussed below in more detail.

In building the catalogue, Trading Platform 102 can build an overall catalogue 108 of rewards by obtaining the product specific catalogue of each supported Loyalty Program. This, in effect, is a listing of all the potential rewards that could be bid on. When a pointsholder registers, the Trading Platform 102 can build the user specific microcatalogue 108a on the basis of the already stored Loyalty Program catalogue, being overall catalogue 108. When a buyer 110 browses the Trading Platform 102 it can show the number of pointsholders that are able to execute the transaction. Selecting the pointsholders able to execute the transaction is simplified by the availability of the microcatalogues 108a. When a bid is submitted, there are a number of different mechanisms that can be used by Trading Platform 102 to select the pointsholder that will execute the transaction. One of the simplest mechanisms, as will be outlined below is that the Trading Platform 102 can issue the offer to all of the pointsholders that can execute the transaction, and then allow the first pointsholder to respond positively to complete the transaction.

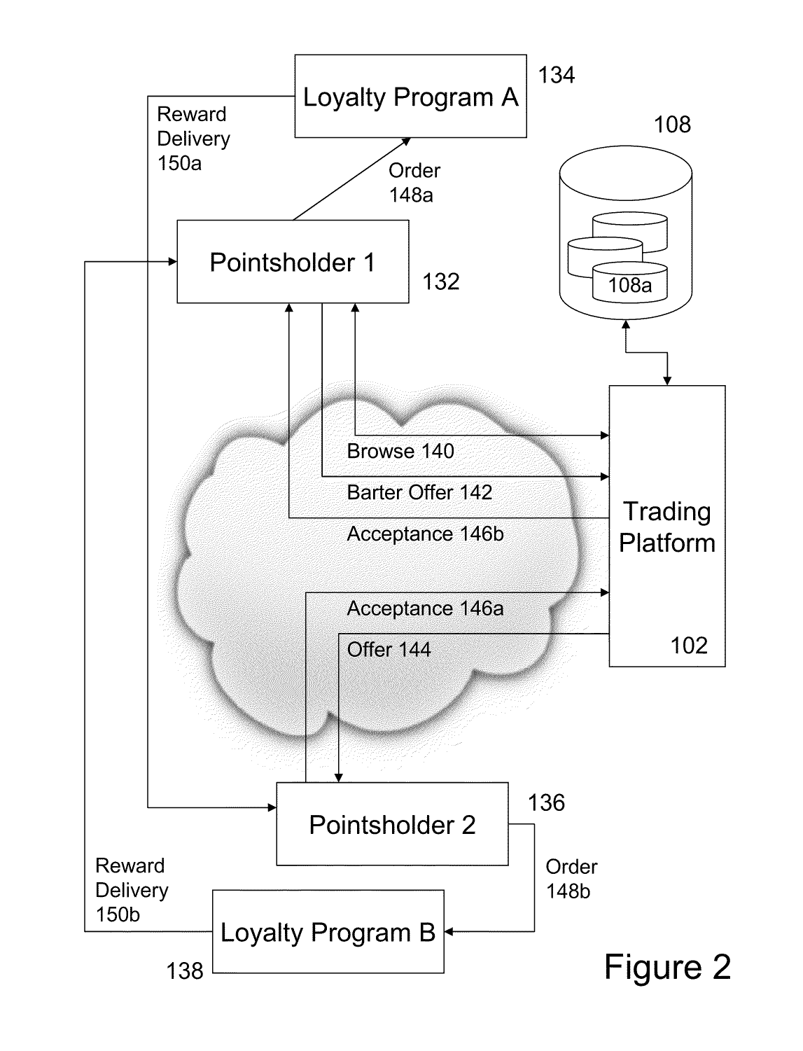

FIG. 2 illustrates another transaction scenario for an exemplary trading platform 102. Pointsholder 1 132 is a member of Loyalty Program A 134, and has an account with Trading Platform 102 which is accessed using a data network such as Internet 104. Pointsholder 2 136 is a member of Loyalty Program B 138 and also has an account with Trading Platform 102.

Pointsholder 1 132 browses Catalog 108 through data flow 140. Upon determining that there is a reward that he would like to barter for, a barter offer 142 is issued to Trading Platform 102. Trading Platform 102 evaluates barter offer 142 and based on the criteria of the barter offer 142 selects Pointsholder 2 136. Trading Platform 102 then transmits offer 144 to Pointsholder 2 136. Offer 144 indicates that instead of a purchase, remuneration is provided by way of barter. The offer is accepted by transmission of an acceptance 146a, which is then relayed to pointsholder 1 132 as acceptance 146b.

At this point, Pointsholder 1 132 and Pointsholder 2 136 have agreed to exchange rewards that are available from Loyalty Program A 134 and Loyalty Program B 138 respectively. Each party has also preferably agreed to remit a matchmaking fee to Trading Platform 102.

After the acceptances 146a and 146b have been relayed, both Pointsholder 1 132 and Pointsholder 2 136 are provided identifying information for the other party, not shown for clarity. Pointsholder 1 132 then issues order A 148a to Loyalty Program A 134, while Pointsholder 2 136 issues order B 148B to Loyalty Program B 138. In the illustrated embodiment, both order A 148a and order B 148b include shipping instructions that have the reward sent to the other party through reward deliveries 150a and 150b respectively.

In a barter transaction, a Pointsholder can indicate that there is a desire for barter on an item, allowing other pointsholders to see the barter offer when they browse catalogue 108, or when a search for all barter offers has been conducted. The offer for barter can specify a class of items that would be accepted for the reward, or it can specify a specific award.

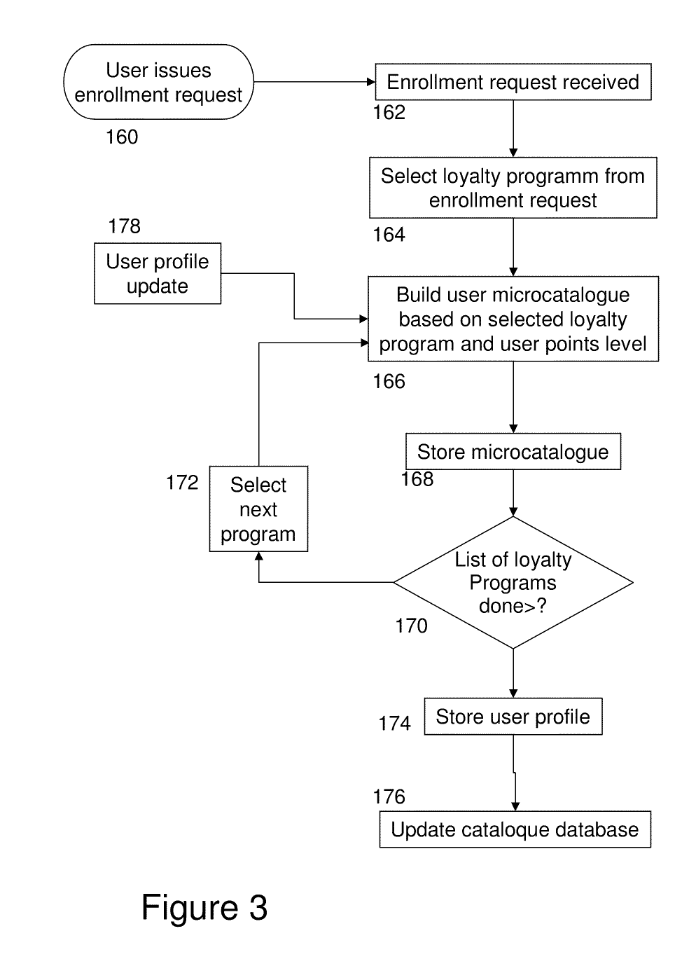

FIG. 3 is a flowchart illustrating a method of pointsholder enrollment with the Trading Platform, and the building of a catalogue based on the enrolled pointsholder. In step 160 a pointsholder (also referred to as a user of the trading platform) issues an enrollment request. Preferably this request identifies the user and lists the loyalty programs to which the user belongs (along with the point levels in each program or along with access rights used to obtain the point level in each program). In step 162 the enrollment request is received by the trading platform. If more than one loyalty program is included in the enrollment, one of the specified programs is selected in step 164, if only one program is specified the process it is selected in step 164. A microcatalogue specific to the user is built in step 166 based on the selected program and the user's point level in the program. This microcatalogue is stored in step 168, and in step 170 a determination is made about whether all loyalty programs in the enrollment request have been processed. If more programs exist, the process continues to step 172 where the next program in the enrollment request is selected, and then returns to step 166 where the user's microcatalogue is expanded. After, in step 170, it has been determined that the list of loyalty programs has been exhausted, the user profile is stored with the microcatalogue in step 174 and the overall system catalogue database is updated in step 176. One skilled in the art will appreciate that as more users join or loyalty programs added, the catalogue is either expanded or the number of users that can execute a transaction for a particular reward item is expanded.

As an optional feature, the trading platform can receive a user profile update in step 178 that informs the trading platform of the user's status in a particular program, or adds or subtracts programs that the user is enrolled with. A trading platform with access to a user's point balance through a programmatic engine can initiate this update at it's own initiative at fixed intervals or after the user has executed a transaction so that a new points level can be determined. After receiving the update in step 178, the process continues to step 166 and follows as described above.

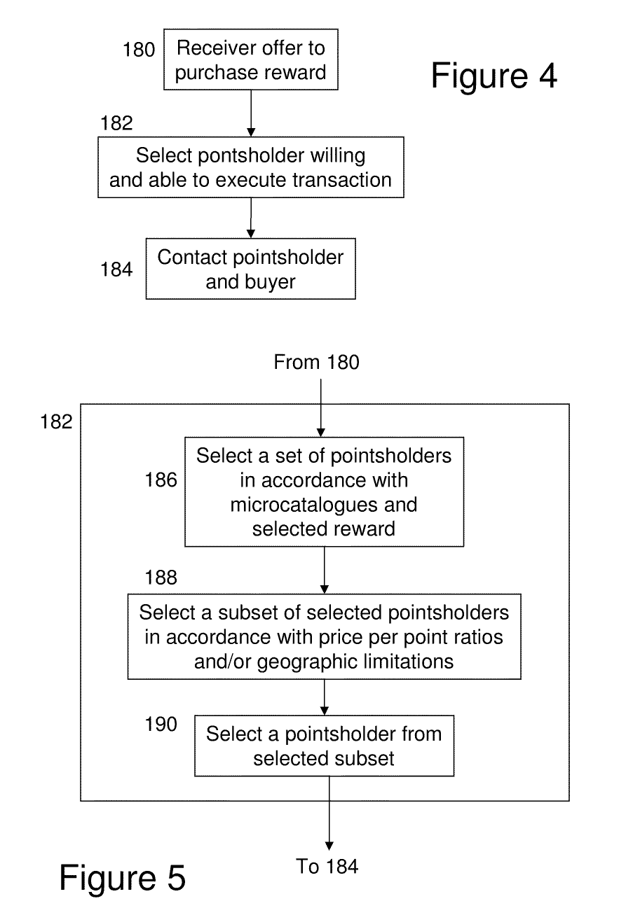

In FIG. 4 a method for carrying out a transaction, such as that described with respect to FIG. 1, is described. In step 180 an offer to purchase a reward from the catalogue of rewards is received. This offer can optionally contain conditions such as a price, a geographic limitation, and other terms and conditions that will be apparent to those skilled in the art. In step 182, a pointsholder willing and able to execute the transaction corresponding to the received offer is selected. One requirement of the pointsholder is that the pointsholder be able to obtain the reward specified by the offer. The manner in which this pointsholder is selected can vary between implementations, and an exemplary method for carrying out this step will be outlined below. In step 184 the pointsholder and buyer are connected to each other. This allows the two parties to execute the transaction. One skilled in the art will appreciate that an offline exchange of the selected reward for the indicated price avoids requirements on the trading platform for building a relationship with the loyalty programs. Furthermore, this step can also include assessing at least one of the buyer and pointsholder a brokerage fee for serving as a matchmaker.

In FIG. 5, an exemplary method of carrying out step 182 is outlined. In step 186, the offer to purchase the reward has been received, and a set of pointsholders is selected in accordance with the contents of their microcatalogues and the selected reward. This initial winnowing process selects only those pointsholders who can obtain the reward selected by the buyer, and allows further winnowing to be carried out using a smaller set of pointsholders. The selected set of pointsholders is further narrowed to a selected subset in step 188. This subset is selected in accordance with a price per point ratio determined by a calculation of the price in the offer to purchase and preferences set in the profiles of the pointsholders in the set selected in step 186. The subset can also be selected in response to geographic limitations on where the selected reward is to be shipped to. This filter requirement can be determined in accordance with the rules of each loyalty program and the location of the buyer. One skilled in the art will appreciate that further filtering can be performed at this point without departing from the scope of the present invention. In step 190, a single pointsholder is selected from the subset selected in step 188. One skilled in the art will appreciate that steps 186 and 188, along with other filtering steps can be combined in a single logical operation, or can be broken into a series of other selection steps without departing from the scope of the present invention. Upon completion of step 190, the process continues to step 184 of FIG. 4.

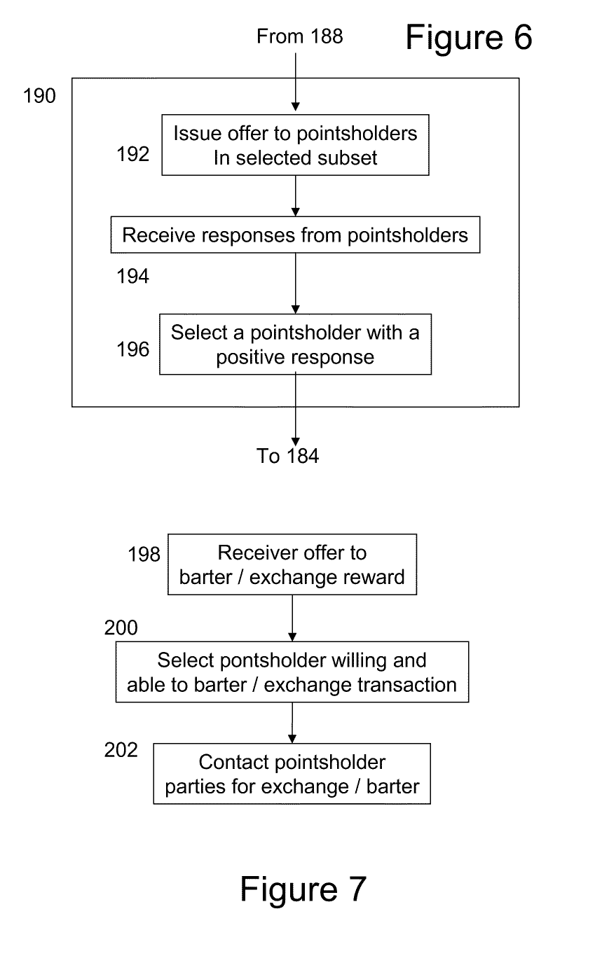

FIG. 6 illustrates a method of carrying out step 190 of FIG. 5. After completing step 188, an offer is issued (step 192) to pointsholders in the subset selected in step 188. In step 194 responses from pointsholders are received. These responses are typically either positive or negative responses, though in some embodiments, the responses can be counter offers that are then relayed to the buyer to allow the buyer to select from the counter offers. If counter offers are received, the buyer is provided the ability to select the pointsholder to execute the transaction on the basis of the provided counter offers. In step 196 a pointsholder with a positive response is selected. As noted above, the selection can be done in accordance with the decision of the buyer in response to a counter offer, or in a system that does not permit (or does not have a counter offer) the decision can be made with any of a number of other factors including selecting the first pointsholder to provide a positive reply, selecting the pointsholder with the best reputation from the positive responses, randomly selecting from among the positive responses, providing a form of a weighted selection based on the number of transactions completed or based on the number of transactions missed, or any of a number of other factors that would be apparent to one skilled in the field. After selecting a pointsholder in step 196, the method continues to step 184 in FIG. 4.

FIG. 7 illustrates a method of matching barter requests such as the one illustrated in FIG. 2. In step 198 an offer to exchange rewards is received. This offer can contain different requirements similar to those described with respect to step 180 of FIG. 4. A pointsholder willing and able to execute the exchange of rewards specified by the offer is selected in step 200. The pointsholding parties are connected in step 202 so that the exchange can occur. One skilled in the art will appreciate that many of the same optional methods for carrying out the step of selecting the pointsholder in step 182 can be applied to the selection of the pointsholder in step 200. Similarly, in the connection of the parties in step 202, one or both of the parties can be assessed a matchmaking fee.

The invention, as disclosed and discussed above, provides a platform that permits pointsholders to either barter rewards with other pointsholders (for instance to allow access to a greater pool of potential rewards) or to monetize their points holdings. This can be obtained with a trading platform and method that does not necessarily require a connection of the trading platform to a loyalty program other than to obtain a catalogue of rewards. This allows for the support of a large number of loyalty programs without involving complex arrangements that slow the expansion of the program.

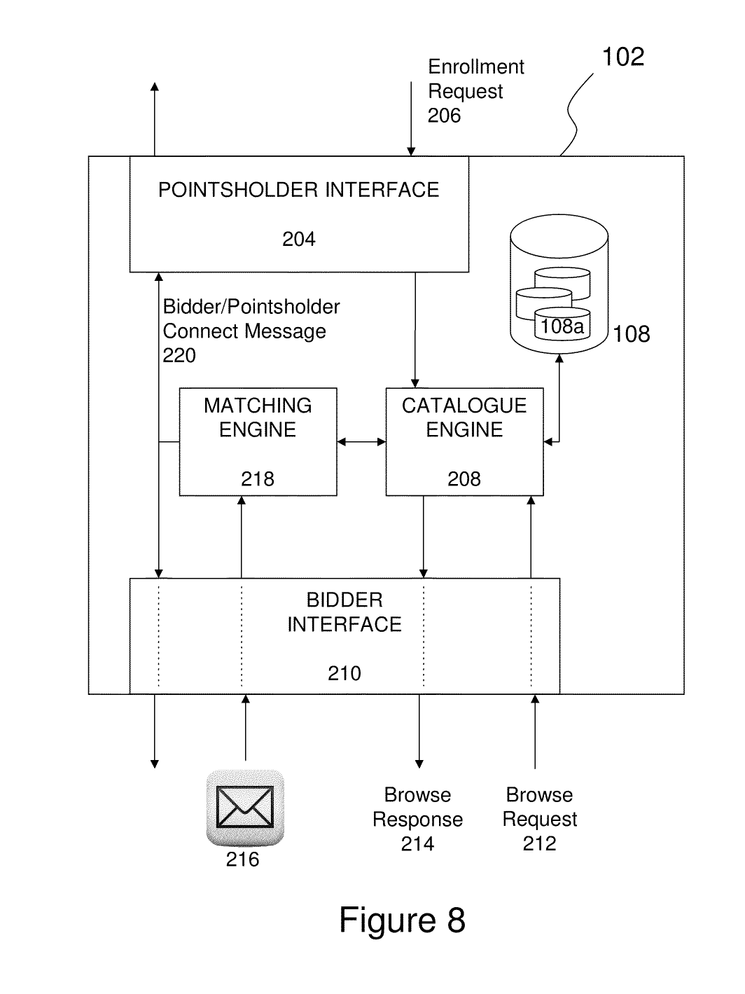

FIG. 8 illustrates an embodiment of the invention as a block diagram. One skilled in the art will appreciate that this diagram seeks to explain the operation of the trading platform of the present invention as a series of logical elements. The functionality of two or more logical elements can be combined or redistributed without departing from the scope of the present invention. One skilled in the art will appreciate that the illustrated embodiment can be implemented on a computer system, or a network of computer systems employing data connections to various elements.

Trading platform 102 includes a pointsholder interface 204 through which communications with the pointsholders can be performed. Pointsholder interface 204 receives enrollment requests 206 and forwards information in the requests to catalogue engine 208. Catalogue engine 208 creates a microcatalogue 108a for each enrolled pointsholder. The microcatalogue 108a reflects the rewards that a pointsholder is able obtain across all the loyalty programs that he is associated with. To fully determine the contents of the microcatalogue 108a, catalogue engine 208 uses the points level of the pointsholder at each of the loyalty programs that the users is associated with, and the reward catalogue for each program. The points levels can either be obtained from the pointsholder in the enrollment request 206 (or in an update message), or they can be obtained from the loyalty program using a back channel. The microcatalogues 108a of each pointsholder are combined to obtain an overall catalogue 108. When a bidder (generically a buyer or a barterer seeking to initiate a transactions) interacts with the trading platform it is done through bidder interface 210. A bidder can issue a browse request 212 which is forwarded by bidder interface 210 to catalogue engine 208. This request typically provides the bidder with a listing of the contents of catalogue 108. The listing can be filtered based on conditions in the browse request 212, and is provided to the bidder as browse response 214 which contains a list of rewards in catalogue 108. The bidder can submit an offer 216 on a selected item from catalogue 108, which is forwarded by bidder interface to matching engine 218. Matching engine 218 selects a pointsholder with whom the bidder can complete the transaction of offer 216. The methods used to select a pointsholder include those described above. Upon selecting a pointsholder, matching engine 218 connects the bidder and the pointsholder by issuing bidder/pointsholder connect messages 220.

One skilled in the art will appreciate that the bidder can provide either an offer for purchase or an offer for barter, and matching engine 218 can select an appropriate pointsholder in accordance with both the ability of a pointsholder to obtain the selected reward (which can be determined by the contents of the microcatalogue 108a associated with each pointsholder) and the willingness of the pointsholder to barter (which can be determined by either confirming the willingness of the pointsholder or by checking a defined preference setting in a profile.)

Those skilled in the art will appreciate that the term bidder and buyer can be used interchangeably when it comes to completing a transaction. Bidders seeking to obtain a reward can be referred to as buyers regardless of whether the offer specifies a purchase price, or a barter value, as payment for a reward can be in the form of either money, or another reward.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

1. A method of matching a buyer to one of a plurality of pointsholders, registered at a trading platform, associated with at least one loyalty program and having points with the at least one loyalty program and having an account with the trading platform stored in a database, the method comprising:
receiving, from the buyer through a network connection, an offer to purchase a selected reward associated with the at least one loyalty program;
selecting, from the database, a pointsholder associated with the at least one loyalty program associated with the selected reward from the plurality of pointsholders; and
connecting the selected pointsholder and buyer to permit the selected pointsholder to sell the reward to the buyer.

2. The method of claim 1 wherein;
the selected reward requires a predetermined number of points in the at least one loyalty management program and the step of selecting a pointsholder includes selecting a pointsholder from the plurality of pointsholders having sufficient points with the at least one loyalty program to acquire the reward.

3. The method of claim 2 wherein;
the step of selecting a pointsholder is done in accordance with pointsholder profiles at the trading platform and a catalogue associated with the at least one loyalty program.

4. The method of claim 2 wherein;
the offer received from the buyer includes conditions including a price.

5. The method of claim 4 wherein;
the step of selecting a pointsholder includes selecting a pointsholder willing to execute a transaction at a price-per-point ratio determined in accordance with the offered price and the catalogue associated with the at least one loyalty program.

6. The method of claim 2 wherein;
the step of selecting a pointsholder includes selecting a set of pointsholders in accordance with the points each of the selected set have with the at least one program, and selecting a pointsholder from the selected set.

7. The method of claim 6 wherein;
the step of selecting a pointsholder from the selected set includes selecting a subset of the selected pointsholders in accordance with at least one of:
predefined price-per-point ratios associated with each of the pointsholders and then selecting a pointsholder from the selected subset, and conditions set forth in the received offer and
predetermined preferences associated with of the pointsholders and then selecting a pointsholder from the selected subset.

8. The method of claim 7 wherein;
the step of selecting a pointsholder from the selected subset includes issuing an offer to pointsholders in the selected subset, receiving a positive response from at least one pointsholder, and selecting one pointsholder associated with a positive response.

9. (canceled)

10. (canceled)

11. The method of claim 1 wherein;
the buyer is a pointsholder registered with the trading platform and the offer to purchase includes a barter value for the selected reward.

12. The method of claim 11 wherein;
the offer to purchase specifies a reward with a loyalty program different from the at least one loyalty program associated with the buyer, and includes a barter value associated with the at least one loyalty program associated with the buyer.

13. The method of claim 12 wherein;
the step of selecting a pointsholder includes selecting a pointsholder associated with at least one loyalty program offering the selected reward.

14. The method of claim 1 wherein;
the step of connecting the selected pointsholder and buyer includes at least one of allowing the buyer and selected pointsholder to complete the transaction outside of the trading platform and assessing a levy on at least one of the buyer and pointsholder.

15. (canceled)

16. The method of claim 1 further comprising:
the step of generating a catalogue of available rewards from which the buyer can select a reward, the catalogue generated in accordance with the available rewards from the at least one loyalty program and the point totals of each of the plurality of pointsholders.

17. The method of claim 16 wherein;
the generated catalogue is a union of a plurality of microcatalogues, each of the plurality of microcatalogues associated with one of the plurality of pointsholders and reflecting the rewards that the associated pointsholder can obtain from the at least one loyalty program associated with the pointsholder.

18. A trading platform for matching buyers of loyalty program rewards to pointsholders associated with a loyalty program, the platform comprising:
a pointsholder interface for receiving enrollment requests from pointsholders associated with at least one loyalty program;
a catalogue engine for generating a microcatalogue for each pointsholder from whom an enrollment request is received, the microcatalogue generated in accordance with the at least one loyalty program associated with the user, and a points level associated with the pointsholder at the at least one associated loyalty program, for generating a catalogue in accordance with any generated microcatalogues, and for providing a list of rewards stored in the generated catalogue in response to a browse request;
a bidder interface for receiving requests to browse the catalogue from a bidder, and for transmitting the list of rewards to the bidder in response to receipt of the list from the catalogue engine, and for receiving from the bidder an offer on a selected reward; and
a matching engine, for examining the offer received through the bidder interface, for selecting a pointsholder associated with a loyalty program determined in accordance with the selected reward, and for connecting the selected pointsholder and the bidder associated with the received offer to permit completion of the transaction outlined in the received offer.

19. The trading platform of claim 18 wherein;
the catalogue engine includes a database for storing the catalogue and microcatalogues.

20. The trading platform of claim 18 wherein;
the matching engine includes means to select a pointsholder in accordance with at least one of conditions associated with the bid and preferences associated with the pointsholder, and with the ability of the pointsholder to obtain the reward from the at least one associated loyalty program.

21. The trading platform of claim 18 wherein;
the matching engine includes means to levy a fee on at least one of the bidder and the selected pointsholder upon connecting the two.

22. The trading platform of claim 18 wherein;
the bidder interface includes means to differentiate between a received offer to purchase and a received offer to barter.

23. The trading platform of claim 18 wherein;
the matching engine includes means to select a pointsholder in accordance with a pointsholder preference for bartering when the received offer is an offer to barter.
